(19) United States
(12) Patent Application Publication
(10) Pub. No.: US 2004/0018836 A1
(43) Pub. Date: Jan. 29, 2004

(54) Service control method using subscriber's location information

(75) Inventor: Min Jang, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/621,403

(22) Filed: Jul. 18, 2003

(30) Foreign Application Priority Data
Jul. 19, 2002 (KR) P-2002-42620

(51) Int. Cl. H04Q 7/20

(52) U.S. Cl. 455/422.1; 455/432.1; 455/466

(57) ABSTRACT

Embodiments of the present invention relate to a method that can limit at least one service to a radio device (e.g. a cellular telephone) according to a location of the radio device. For example, a user can program a cellular telephone, so he/she can receive e-mail messages on their cellular phone when they are work and not receive them when they are home.

This application claims the benefit of the Korean Application No. P2002-42620 filed on Jul. 19, 2002, which is hereby incorporated by reference.

### BACKGROUND OF THE INVENTION

1. Field of the Invention

Embodiments of the present invention generally relates to communications.

2. Background of the Related Art

Many different features are available in cellular phones. In fact, sometimes the amount of features available can be an inconvenience for a cellular phone user. Accordingly, it is sometimes desirable for a cellular phone user to turn off features. However, sometimes the user wishes to turn off features in some circumstances and keep them on in other circumstances. For example, a cellular phone user may use the cellular phone for both business use and home use. When this exemplary user is at work, he may desire to receive e-mail messages on his cellular phone. However, when the user is at home, the user may not wish to be bothered with e-mail messages. Accordingly, the user may wish to have the e-mail feature turned off when they are at home and turned on when they are at work. Further, it may be desirable for this limitation on e-mail on a cellular phone to occur automatically. In other words, it may be desirable if the cellular phone system could automatically detect whether the user is at work or at home, so the cellular telephone system will know whether to transmit e-mail messages to the users cellular phone.

### SUMMARY OF THE INVENTION

Embodiments of the present invention relate to a method that can limit at least one service to a radio device (e.g. a cellular telephone) according to a location of the radio device. For example, a user can program a cellular telephone, so he/she can receive e-mail messages on their cellular phone when they are work and not receive them when they are home.

### BRIEF DESCRIPTION OF THE DRAWINGS

FIG. 1 is an exemplary view illustrating network construction for mobile communication service.

FIG. 2 is an exemplary flowchart illustrating a mobile communication service processing procedure according to a call limit method using location information.

FIG. 3 is an exemplary flowchart illustrating a mobile communication service processing procedure when a handover occurs.

FIG. 4 is an exemplary flowchart illustrating a processing procedure when a subscriber profile is changed.

### DETAILED DESCRIPTION OF PREFERRED EMBODIMENTS

In a mobile communication system, a limit of a service may be irrespective of the location at which a subscriber has requested the service. For example, when the subscriber registers mobile communication service, information on limits of an originating call, terminating call, originating short message service (SMS), terminating SMS, additional service, roaming, etc., may be predefined in a subscriber service profile of a home location register. The subscriber may request a service and the service may be limited according to a registered service profile.

For example, when a mobile communication service subscriber enters into a specified service, they may pre-register information for a service limit in the subscriber profile in the home location register (HLR). An exchange, during registration of the subscriber's location, may receive the subscriber profile, that contains service limit information of the subscriber, from the HLR. For example, if the subscriber desires terminating call service only, the subscriber may request a limit to other remaining services (e.g. terminating SMS messages) except for terminating call service. Accordingly, if originating call service is requested with respect to the subscriber, the exchange checks if the subscriber has registered an originating call service limit with reference to the subscriber profile. If the originating call service limit is registered as a result of checking, the subscriber may not be able to receive originating call service and may be informed of this fact.

A communication system may limit originating call service, terminating call service, additional service, SMS service, roaming service, etc. However, not all communication systems consider location information of the subscriber when limiting service. For example, in these communication systems, if a mobile subscriber wishes to request the service limit in a specified location or in a place except for a specified location, a service limit in accordance with the subscriber's location may not be possible. As an example, a subscriber may desire to limit terminating call service in order to prevent someone located in an area nearby his/her house from making a call to him/her. As another example, a subscriber may desire a service limit so that he/she does not receive originating call service and SMS service in a specified area. Accordingly, mobile communication subscribers may desire control of the mobile communication service in relation to a desired specified geographic area.

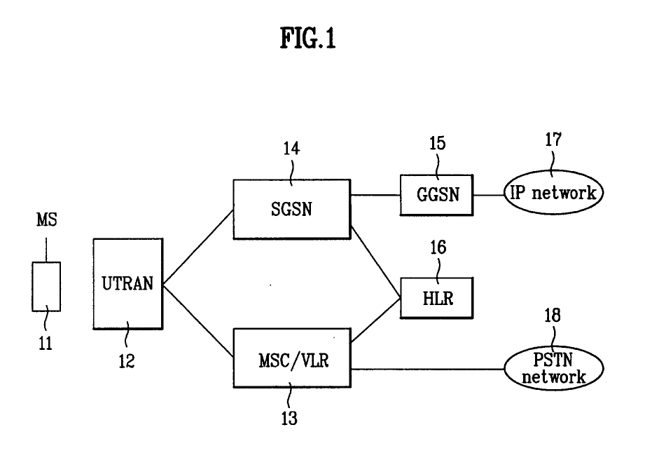

FIG. 1 is an exemplary view illustrating network construction of a mobile communication system according to embodiments of the present invention. Embodiments of the present invention may be for heightening efficiency of service limits using location information of a mobile communication subscriber in a mobile communication system. For example, limit items according to the subscriber's location during the subscriber's subscription or change of the service may be registered in a subscriber's service profile.

A service profile, registered in an HLR during the subscriber's location registration, may be accessed and it may be determined if service requested by the subscriber is compatible with the location from which service is requested. If there is a service limit, service may be limited and a message may be transmitted to the subscriber informing them of the service limit.

Referring to FIG. 1, a mobile communication system, according to embodiments of the present invention, may include an Internet protocol network 17, a public switched telephone network (PSTN) 18, a gateway general packet radio service (GPRS) support node (hereinafter referred to as GGSN) 15, a packet exchanger 14, a home location register (HLR) 16, a circuit exchanger 13, a universal terrestrial radio network (UTRAN) 12, and/or a mobile terminal 11. The mobile communication exchange, according to the type of service, may be divided into a packet exchange 14 and circuit exchange 13. Packet exchange 14 may take charge of packet service (e.g. Internet connection). Circuit exchange 13 may take charge of circuit service (e.g. an existing telephone network connection).

Packet exchange 14, which may manage the mobility of mobile terminal 11 in packet mode, may comprise a serving GPRS support node (SGSN). SGSN may be for a general packet radio service (GPRS) that is an asynchronous packet service. SGSN may be connected to gateway GPRS support node (GGSN) 15 for connecting to Internet protocol (IP) network 17. Circuit exchange 13 may include a mobile switching center (MSC) and a visitor location register (VLR). Circuit exchange 13 may be connected to public switched telephone network (PSTN) 18.

GGSN 15 may perform a gateway function for connecting to IP network 17. HLR 16 may be coupled to packet exchanger 14 and/or circuit exchanger 13. HLR 16 may manage subscriber information and/or location information. UTRAN 12 may manage radio resources and/or may perform data transmission/reception with mobile terminal 11 by allocating a traffic channel.

The location of a mobile subscriber may be expressed through identifiers. Examples of identifiers are location area identifiers (LAI), routing area identifiers (RAI), and service area identifiers (SAI). A mobile communication service subscriber may have all three identifiers, since a subscriber may receive circuit service and packet service simultaneously. A subscriber operating only circuit service may only have a location area identifier (LAI) and a service area identifier (SAI). A subscriber operating only packet service may only have a routing area identifier (RAI) and a service area identifier (SAI).

Examples of subscriber services are circuit originating calls, circuit terminating calls, originating SMS services, terminating SMS services, additional services, roaming services, packet originating calls, and packet terminating calls. In embodiments, these subscriber services may be limited according to the location of the mobile communication service subscriber. In order to register a service limit according to the location of the subscriber, the mobile communication service subscriber may register the service limit contents in a service profile of the subscriber in a HLR.

Table 1 is an exemplary illustration of a subscriber's service limit information according to the location information registered in the subscriber profile, according to embodiments of the present invention.

TABLE 1

| | Circuit | Circuit | Ori. | Ter. | | Roam- | Packet | Packet |
|---|---|---|---|---|---|---|---|---|
| Location | Orig. | Term. | SMS | SMS | Add. | ing | Orig. | Term. |
| Infor- | Call | Call | Service | Service | Service | Service | Call | Call |
| mation | Limit | Limit | Limit | Limit | Limit | Limit | Limit | Limit |
| LAI = A | ON | ON | OFF | OFF | OFF | OFF | ON | ON |
| RAI = B | OFF | OFF | OFF | OFF | OFF | ON | OFF | OFF |
| SAI = C | ON | ON | ON | ON | ON | ON | ON | ON |
| . . . | | | | | | | | |

Through exemplary Table 1, service limit information of a subscriber according to location information of the subscriber is registered. In this example, if location area identifier (LAI) of a subscriber is value A, the subscriber's circuit and packet originating/terminating calls are limited in the location corresponding to value A. Also, in this example, if routing area identifier (RAI) is value B, the subscriber's roaming service is limited in the location corresponding to value B. In this example, if service area identifier (SAI) is value C, then all the services are limited.

A service limit according to location information of a certain subscriber may utilize different types of location information. It may be possible to register several location area identifiers (LAIs), routing area identifiers (RAIs), and/or service area identifiers (SAIs) as service limit areas.

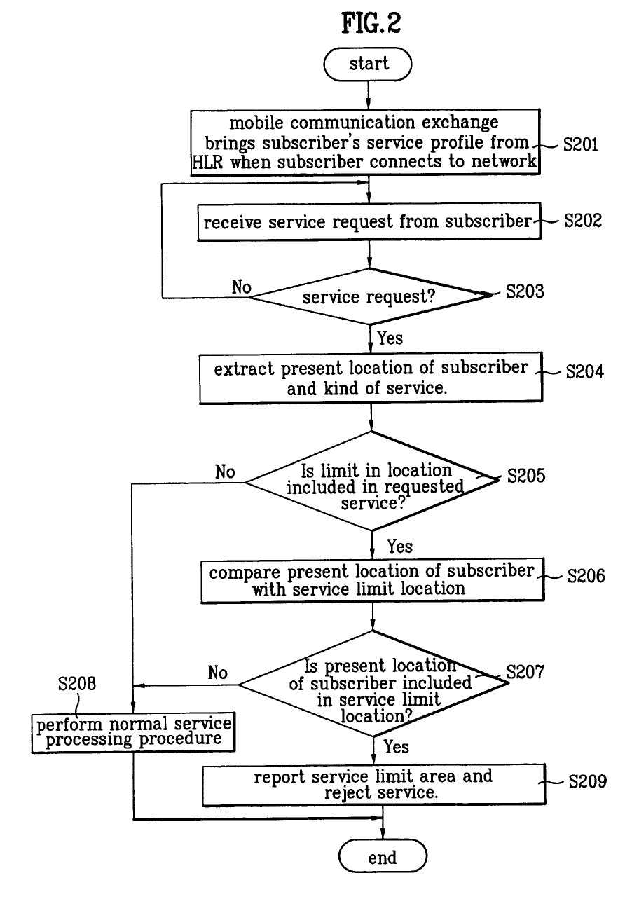

FIG. 2 is an exemplary flowchart illustrating a mobile communication service procedure in a mobile communication exchange using service limit information, according to embodiments of the present invention. In order to register a service limit according to location, during subscription or change of service, a mobile communication service subscriber may have to register a service limit according to location in a service profile in HLR 16.

A subscriber who has subscribed to a service limit according to the location may register his/her own location in the mobile communication exchange (e.g. a packet exchange 14 or circuit exchange 13). The mobile communication exchange may bring a service profile of the subscriber from HLR 16. The service profile of the subscriber may be transmitted from HLR 16 to the mobile communication exchange (step S201). The subscriber's service profile may be received from HLR 16 when a terminal of the mobile communication subscriber initially connects to the network. Since the subscriber's service profile has a large size, the terminal may receive the profile during initial network connection and then may automatically receive the profile from HLR 16 whenever the service limit contents according to the location are changed.

When a subscriber terminal connects to a mobile communication network, it may request diverse kinds of services. This type of request may also occur, as the subscriber terminal moves within the mobile communication network (step S202). During a service request, a terminal may input the type of service, along with variables required for the service. The subscriber's location information may be automatically transmitted to the exchange along with the service request message. In embodiments, for circuit service, the subscriber's location information may be transmitted along with a location area identifier (LAI) and/or a service area identifier (SAI). In embodiments, for packet service, location information may be transmitted along with a routing area identifier (RAI) and/or a service area identifier (SAI).

If a service request is received from a subscriber's terminal or another terminal (step S203), the mobile communication exchange may extract the location of the subscriber and/or the kind of service requested (step S204). As illustrated in exemplary Table 1, subscriber's services that may be limited according to location of the mobile communication service subscriber may be a circuit originating call, circuit terminating call, originating SMS service, terminating SMS service, additional service, roaming service, packet originating call, and/or packet terminating call.

Circuit originating calls, originating SMS service, packet originating calls, etc., are elements which may be subject to a service limit when a subscriber, who has registered the service limit according to the location information, requests the service. Circuit terminating calls, terminating SMS service, packet terminating calls, etc., are elements which may be subject to a service limit when a third patty calls the subscriber.

A mobile communication exchange may receive a service request from a subscriber who has registered a service limit according to location information or from a mobile communication subscriber who calls the subscriber. The mobile communication exchange may determine if there is a limit in the location for the extracted (e.g., requested) service (step S205). If it is determined that there is no limit in location, the exchange may perform a normal service processing procedure (step S208). Alternatively, the exchange may compare the location of the subscriber with the location information of the service limit (step S206). If the location of the subscriber is not included in the service limit location, the mobile communication exchange may perform normal service processing procedure (steps S207 and S208). If the location of the subscriber corresponds to the service limit location, the mobile communication exchange may report the service limit area and/or may reject the service (step S209).

If a subscriber requests service (e.g. circuit originating call, originating SMS service, packet originating call, etc.) in a service limit area, then a mobile communication exchange may report to the subscriber that the area is the service limit area. Likewise, if a third party requests packet service, circuit service, and/or SMS service to the subscriber, when the subscriber is located in the service limit area, the mobile communication exchange may inform the third party mobile terminal that the subscriber is in a service limit area.

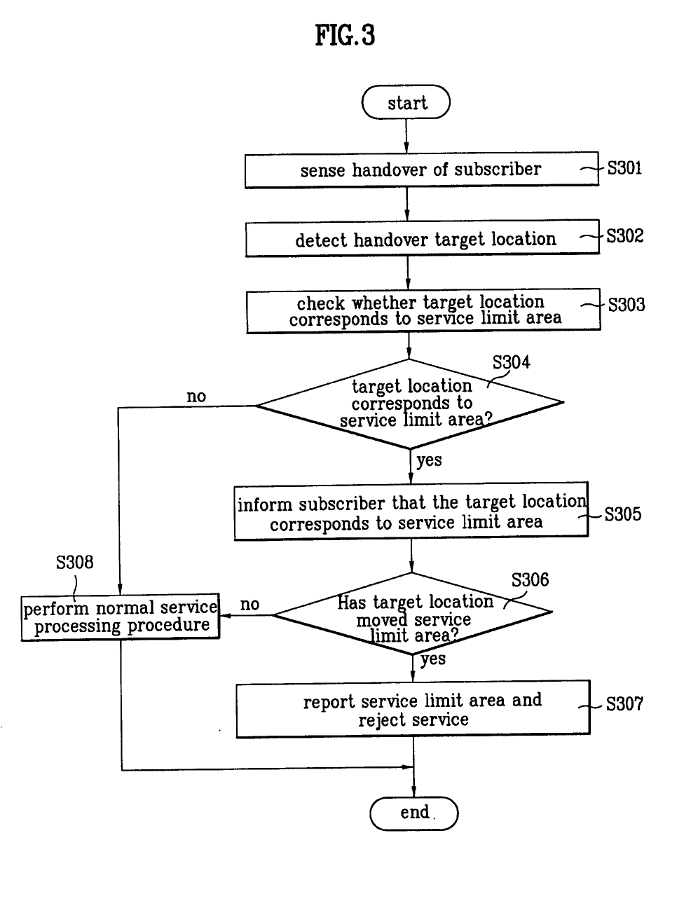

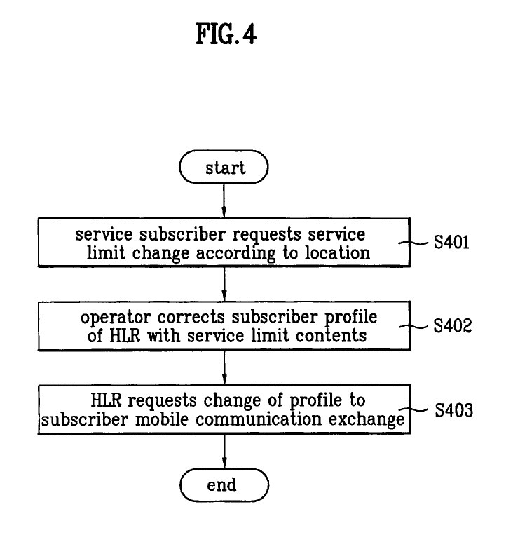

FIG. 3 is an exemplary flowchart illustrating a mobile communication service procedure when a handover is produced. FIG. 4 is an exemplary flowchart illustrating a processing procedure when a subscriber profile is changed.

In accordance with embodiments of the present invention, FIG. 3 illustrates a service processing procedure during a handover to a service limit area. The handover may be when a mobile terminal switches communication from an initial base station service area (i.e., cell boundary) to an adjacent base station service area. If a handover for moving the mobile terminal to the service limit area is produced while the service subscriber is receiving the service, the mobile communication exchange may detect the generation of the handover while receiving the service (step S301). If a handover is detected by the mobile communication exchange, it may seize the location of a handover target area (step S302). If the location of the handover area is seized, it may be determined if the target location corresponds to the service limit area (step S303).

If it is determined at step S304 that the target location does not correspond to the service limit area, a normal service processing procedure may be performed (step S308). Alternatively, if it is determined that the target location corresponds to the service limit area, the subscriber may be informed that the currently proceeding service is handed over to a service limit area (step S305). It may be determined if the subscriber disregards notice of the service limit and proceeds into the service limit area (step S306). In other words, the subscriber, who has been informed that he/she is moving to the service limit area at step S305, is given the opportunity to decide whether he/she will stop movement in order to continue to receive the service. If the subscriber does not completely move into the service limit area at step S306, a normal service processing procedure may be performed (step S308). Alternatively, if the subscriber completely moves into the target location and the handover is completed, the subscriber may be informed of the service limit contents and the service may be released (step S307).

As illustrated in exemplary FIG. 4, a service subscriber may request for a change of the limit contents of the mobile communication service, according to location information (step S401). If the request for the change of the limit contents is accepted, an operator may change the service limit contents by correcting the subscriber profile of the HLR, according to the change request information (step S402). If the change of the service limit contents is completed, the changed service limit contents may be transmitted to the mobile communication exchange and the subscriber profile may be corrected (step S403). A request for a change of the service limit contents may occur if the subscriber desires the service in the service limit area.

Embodiments of the present invention provides a method for registering service limit contents according to location information of a subscriber in an HLR. Embodiments of the present invention relate to a method for storing the registered service limit contents in a mobile communication exchange when the subscriber connects to a network and limiting a service according to the requested service contents and location in which the service is requested when the subscriber requests the service. Embodiments of the present invention can exquisitely control the mobile communication service by dividing the service limit according to the location information.

Embodiments of the present invention are directed to a service control method using subscriber's location information. An object of embodiments of the present invention is to provide a service control method using subscriber's location information that can provide a diverse and exquisite service control by permitting or limiting a service requested by the subscriber using the subscriber's location information.

To achieve these objects and other advantages and in accordance with the purpose of embodiments of t he invention, a service control method using subscriber's location information for a mobile communication system includes the steps of registering information on a service limit according to a subscriber's location in a service profile of the subscriber during a service change or subscription, and if a service request is received, limiting the service on the basis of the mobile terminal subscriber's location information using registered contents of the subscriber's service profile.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method comprising limiting at least one service to a radio device according to a location of the radio device.

2. The method of claim 1, wherein the radio device is a mobile station.

3. The method of claim 1, wherein said at least one service comprises at least one of:
a circuit originating call;
a circuit terminating call;
originating short message service;
terminating short message service;
additional service;
roaming service;
a packet originating call; and
a packet terminating call.

4. The method of claim 1, wherein the method is implemented in a mobile communication exchange.

5. The method of claim 4, wherein the mobile communication exchange comprises at least one of a packet exchange and a circuit exchange.

6. The method of claim 5, wherein:
the packet exchange comprises a serving GPRS support node; and
the circuit exchange comprises a mobile switching center and a visitor location register.

7. The method of claim 4, wherein:
the mobile communication exchange is coupled to a home location register;
the mobile communication exchange is coupled to a universal terrestrial radio network; and
the mobile communication exchange is coupled to one of a public switched telephone network and an Internet protocol network.

8. The method of claim 7, wherein the mobile communication exchange is coupled to the Internet protocol network through a gateway GPRS support node.

9. The method of claim 1, comprising comparing the location of the radio device with a register, wherein the register comprises at least one predetermined relationship between location of the radio device and limitations on at least one service to the radio device.

10. The method of claim 9, wherein said limiting at least one service to a radio device according to the location of the radio device is in accordance with said at least one predetermined relationship comprised in the register.

11. The method of claim 9, wherein the register is a home location register.

12. The method of claim 1, wherein the location of the radio device is represented by at least one of:
a location area identifier;
a service area identifier; and
a routing area identifier.

13. The method of claim 12, wherein:
the location area identifier and the service area identifier are used for circuit service; and
the routing area identifier and the service area identifier are used for packet service.

14. The method of claim 1, wherein prior to said limiting at least one service to the radio device, comprising:
detecting a handover of the radio device to a new location; and
prior completing the handover to the new location, informing a user of the radio device that at least one service to the radio device will be limited once the handover is complete.

15. The method of claim 1, wherein said limiting is in accordance with a request from a user of the radio device to limit at least one service to the radio device according to the location of the radio device.

16. An apparatus configured to implement the method of claim 1.

17. An apparatus comprising:
a home location register comprising predetermined relationships between limitations on subscriber services and location of a mobile station; and
a means for limiting a subscriber service to the mobile station according to the home location register.

18. A service control method using subscriber's location information for a mobile communication system comprising the steps of:
registering information on a service limit according to a subscriber's location in a service profile of the subscriber during a service change or subscription; and
if a service request is received, limiting the service on the basis of the mobile terminal subscriber's location information using registered contents of the subscriber's service profile.

19. The service control method of claim 18, wherein the subscriber's location information for limiting the service is expressed by a location area identifier (LAI), a routing area identifier (RAI), and a service area identifier (SAI).

20. The service control method of claim 18, wherein contents of the limited service include a circuit originating call, a circuit terminating call, an originating SMS service, a terminating SMS service, an additional service, a roaming service, a packet originating call, and a packet terminating call.

21. The service control method of claim 18, further comprising the step of, if the mobile communication subscriber initially connects to a mobile communication network after the information on the service limit according to the subscriber's location is registered in the service profile of the subscriber, transmitting the subscriber profile including service limit contents from a home location register to a mobile communication exchange to store the subscriber profile.

22. The service control method of claim 18, further comprising, when the subscriber requests the service, the steps of:
transmitting service contents and the location information to a mobile communication exchange;
comparing the transmitted service and a service request location with the service profile of the subscriber; and
if the service limit contents according to the service request area coincide with each other, informing the service limit contents to the mobile terminal subscriber, and rejecting the service.

23. The service control method of claim 18, further comprising, if a handover made by movement of the mobile terminal into a service limit area is produced while the subscriber is receiving the service, the steps of:
sensing the handover;
detecting a target location of the handover;
checking whether the target location corresponds to the service limit location;
if the target location corresponds to the service limit area, informing the service limit area; and
if the handover is made into the service limit area, informing the area in which the service is limited, and releasing the service.

24. The service control method of claim 18, further comprising, if the subscriber requests a change of service limit contents according to the subscriber's location, the steps of:
receiving a request for the change of the service limit contents from the subscriber;
correcting the service profile of the subscriber according to contents of the request; and
requesting the change by transmitting the corrected profile to a mobile communication exchange.

25. A service control method using subscriber's location information for a mobile communication system provided with a mobile terminal, a home location register (HLR), and a mobile communication exchange, the method comprising:
a first step of registering a service limit according to the location information;
a second step of extracting a kind of a service requested during a service request and a location of a subscriber; and
a third step of limiting the service if a present location of the subscriber is included in a limited location of the extracted service.

26. The service control method of claim 25, wherein the first step comprises the steps of:
storing contents of the service limit according to the location information in the HLR; and
if the subscriber's mobile terminal connects to a mobile communication network, the mobile communication exchange reading out a service limit profile according to the location information from the HLR.

27. The service control method of claim 25, wherein the second step comprises the steps of:
the mobile communication exchange receiving the service request from the mobile terminal; and
the mobile communication exchange extracting the location of the mobile terminal that has registered the service limit according to the kind of the received service and the location information.

28. The service control method of claim 25, wherein the third step comprises the steps of:
the mobile communication exchange judging whether there is a location limit in the extracted service, and if it is judged that there is no location limit in the extracted service, normally processing the requested service;
normally processing the requested service if there is the location limit in the extracted service, but the present location of the subscriber is not included in the limited location; and
reporting the service limit area and refusing the service if the present location of the subscriber is included in the limited location of the extracted service.

29. The service control method of claim 25, wherein at the first step, the service limit is effected by registering at least one limited area among a location area identifier (LAI), a routing area identifier (RAI), and a service area identifier (SAI).

30. The service control method of claim 25, wherein contents of the limited service include a circuit originating call, a circuit terminating call, an originating SMS service, a terminating SMS service, an additional service, a roaming service, a packet originating call, and a packet terminating call.

31. The service control method of claim 25, wherein at the second step, the mobile terminal requests a service request message including variables required for the service, the kind of the service, and the location information to the mobile communication exchange during the service request.

32. A service control method using subscriber's location information for a mobile communication system provided with a mobile terminal, a home location register (HLR), and a mobile communication exchange, the method comprising:
a first step of registering a service limit according to the location information;
a second step of detecting a handover target location of the subscriber who has registered the service limit according to the location information when the subscriber receives the service; and
a third step of releasing the service if a handover to the service limit area occurs.

33. The service control method of claim 32, further comprising the step of reporting in advance the subscriber of the service limit area if the target location moves to the service limit location before the third step.
